(19) United States
(12) Patent Application Publication
(10) Pub. No.: US 2023/0271846 A1
(43) Pub. Date: Aug. 31, 2023

(54) METHOD FOR PRODUCING METAL AND/OR METALLOID COMPOUNDS IN AN IONIC LIQUID

(71) Applicant: Nanomox Ltd, London (GB)

(72) Inventors: Francisco Malaret, London (GB); Kyra Lauren Sedransk Campbell, Sheffield (GB); Jason Patrick Hallett, London (GB)

(21) Appl. No.: 18/012,157

(22) PCT Filed: Jun. 22, 2021
(86) PCT No.: PCT/GB2021/051575

§ 371 Date: Dec. 21, 2022

(30) Foreign Application Priority Data
Jun. 22, 2020 (GB) 2009470.2

(51) Int. Cl. C01G 9/00; C01G 9/02

(52) U.S. Cl. CPC C01G 9/006; C01G 9/02; C01P 2002/85; C01P 2004/03

(57) ABSTRACT

The disclosure provides a method of producing a metal compound. The method comprises contacting a metal source with a reaction mixture, wherein the reaction mixture comprises an ionic liquid and an oxidising agent, and thereby producing the metal compound.

### FIELD OF THE INVENTION

The invention relates to a method for the production of metal and/or metalloid compounds, including but not limited to oxides and hydroxides. The metal and metalloid compounds may be obtained in several forms, such as microparticles, nano-objects, or films.

### BACKGROUND OF THE INVENTION

There is a global trend to reduce the impact of industrial processes on the environment. This broadly translates to a wide range of changes to the industrial sector focused on reducing waste, energy consumption and/or mitigating the environmental impact. In some instances these improvements are achieved through modest adaptations to existing technology and in other cases paradigm-shifting approaches in technology are being implemented to address these challenges. In the field of metal-based syntheses, particularly in the formation of metal oxides (or closely related species) some efforts have been made, albeit most on a small (laboratory) scale. However, the promise of many of these technological developments has not been realised, either due to insurmountable costs or a failure to be able to scale to industrial demand. Most common methods for metal oxide production at large scale (nanoparticles, microparticles or films) are not sustainable as they require high temperatures to oxidize the metals or utilize dangerous chemicals such as acids. Currently, a duality exists in addressing the synthetic route of metal oxides. Fabrication of sufficient quantity and targeted synthesis for some applications, including the often cited need for controlled particle morphology and size. A particularly pertinent example is for applications demanding nano-sized particles and films, which are difficult to achieve at scale with the desired specifications (and tolerances).

Ionic liquids are salts with low melting points, resulting from weak cation-anion attractive forces, as opposed to conventional ionic salts which exhibit strong interactions. This is due to the nature of the constituent ions such as asymmetry or size. The weak attractive forces causes these substances to be liquid over a wide range of temperatures, including room temperature or lower in a large number of cases. Compared with conventional organic solvents, ionic liquids have extremely low volatilities, are non-flammable and are chemically and thermally stable, they have high thermal and ionic conductivity, high heat capacity, etc. These features mean that the use of ionic liquids reduces hazards (thereby improving safety) and reduces environmental impact.

Ionic liquids is an overarching term, where the chemistry can be exceptionally broad as defined by the individual cations and anions employed. With respect to metal oxide (and other metal based materials) production, the great number of different ionic liquids makes it possible to design a solvent with the right properties to control the size and shape of the particles formed. In the synthesis of metal-based species (e.g. metal oxides), the ability of ionic liquids to act as a conductor provides an additional benefit in facilitating the electrochemical (e.g. oxidation and reduction) and chemical reactions to occur.

Some work has been reported on the synthesis of particles, notably nanoparticles, employing solutions containing ionic liquids. However, work up until now has had limited focus. This has included narrow investigations of (nano) particles which can be produced, the ease with which the nanoparticles can be separated from other reaction products and the recyclability of the ionic liquid, thus limiting the practical applicability of the known approaches. Also, the cost of ionic liquids can be extremely high, so procedures for recycling ionic liquids after use are needed to increase the practical applicability of ionic liquids.

Most methods published in literatures and previous patents, to prepare nanoparticles in ionic liquids, use reducible metal precursors as a metal source, such as metallic salts and organometallic compounds. This have several drawbacks.

In particular, metal salts are generally more expensive when normalized to the metal content. Some metals salts are produced industrially from metals, which implies more energy consumption, processing steps, chemicals used and waste generated. The anions present in the metallic salts may accumulate in the ionic liquid system, which will increase processing cost to recycle the ionic liquid, may co-precipitate with the products leading to contamination and extra process steps for purification, this ultimately will lead to more energy consumption, high capital investment cost, more chemical consumption and more waste generated.

Another problem reported for prior art hydrothermal methods, especially for nanoparticles, is agglomeration of particles, for which surfactant or stabilizing agents are required.

The present invention arises from the inventors' work in attempting to overcome the problems associated with the prior art.

### SUMMARY

In accordance with a first aspect of the invention, there is provided a method of producing a metal and/or metalloid compound, the method comprising contacting a metal and/or metalloid source with a reaction mixture, wherein the reaction mixture comprises an ionic liquid and an oxidising agent, and thereby producing the metal and/or metalloid compound.

Ionic liquids (ILs) can be electrically conductive. This differentiates ILs from traditional organic solvents, and can be employed to achieve an oxidation reaction of a metal and/or metalloid source immersed in the ionic liquid. Additionally ILs can self-assemble, and this can be exploited as a mechanism for templating crystal nucleation and growth. The molecular organisation of ionic liquids, as a function of solution conditions, has been demonstrated to provide control over not only the chemistry of the resulting metal and/or metalloid compound species, but also the morphology/habit/size. This capability, when harnessed, allows for very well controlled synthesis (i.e. tunability) of the desired final product. Additionally, the property of self-assembly in solution also offers an additional benefit that suspensions of particles can be stabilized without a surfactant, or other similar mechanism, to reduce, or even eliminate, unwanted behaviours including agglomeration and coalescence of the particles. This adds further advantages of the synthetic route including good reaction control and improved ease of product separation (with the potential for IL recovery).

Metal and/or metalloid compounds produced using the above method may be used as catalysts for chemical reactions, in fuel cells, in a sensing device, in a super capacitor or as a battery component.

The metal and/or metalloid source may comprise or consist of a pure metal, a pure metalloid, an impure metal, an impure metalloid, an alloy, a metal containing compound, a metalloid containing compound or a solution comprising metal and/or metalloid ions. In some embodiments, the metal and/or metalloid source is a metal source. The metal source may comprise or consist of a pure metal, an impure metal, an alloy or a metal containing compound.

An impure metal and/or metalloid may be a metal and/or metalloid which has been recovered or recycled. The metal and/or metalloid in the metal and/or metalloid containing compound may have an oxidation state of zero or a low oxidation state. The metal and/or metalloid may be understood to have a low oxidative state if it can be further oxidised through an electrochemical or chemical reaction. The metal and/or metalloid source may comprise a composite structure. The composite structure may comprise a metal and/or metalloid within another material. The metal and/or metalloid source may be a solid, a liquid or it may be present in a solution. In some embodiments, the metal and/or metalloid source is solid. It may be appreciated that the metal and/or metalloid source may be sized from the nano-meter to the meter scale. The metal and/or metalloid source may comprise an ingot, a sheet, a wire, a tube, a solid bar or a powders.

The metal and/or metalloid source may comprise or consist of aluminium, antimony, arsenic, astatine, barium, beryllium, bismuth, boron, cadmium, caesium, calcium, cerium, chromium, cobalt, copper, dysprosium, erbium, europium, gadolinium, gallium, germanium, gold, hafnium, holmium, indium, iridium, iron, lanthanum, lead, lithium, lutetium, magnesium, manganese, mercury, molybdenum, neodymium, nickel, niobium, osmium, palladium, platinum, polonium, potassium, praseodymium, rhenium, rhodium, rubidium, ruthenium, samarium, scandium, selenium, silicon, silver, sodium, tantalum, tellurium, terbium, thorium, thulium, tin, titanium, tungsten, uranium, vanadium, ytterbium, yttrium, zinc and/or zirconium. It may be appreciated that antimony, arsenic, astatine, boron, germanium, polonium, selenium, silicon and tellurium are metalloids.

An alloy may comprise two or more metals. The alloy may be an iron alloy, a mercury alloy, a tin alloy, a copper alloy, an aluminium alloy, a titanium alloy, a nickel alloy, a cobalt alloy, a silver alloy, a gold alloy and/or a bismuth alloy. An iron alloy may be alnico (i.e. an alloy comprising iron, aluminium, nickel and cobalt), cast iron, a nickel-iron alloy or steel. A mercury alloy may be an amalgam. A tin alloy may be a babbitt metal (e.g. an alloy comprising tin and antimony and optionally further comprising lead, copper and/or arsenic) or pewter (e.g. an alloy comprising tin, antimony, copper and nismuth, and optionally also silver). An aluminium alloy may be a magnesium-aluminium alloy. A nickel alloy may be nichrome (i.e. an alloy comprising nickel and chromium, and optionally also iron) or a nickel-titanium alloy. A cobalt alloy may be a cobalt-chromium alloy (e.g. Stellite). A silver alloy may be sterling silver. A gold alloy may be white gold. A bismuth alloy may be Wood's metal (e.g. an alloy comprising bismuth, lead, tin and cadmium).

No specific metallurgical processing or post-processing surface treatments are required. However, the method may comprise such treatments may be employed to enhance the method. In some embodiments, the method comprises chemically and/or mechanically cleaning, polishing and/or etching the metal and/or metalloid source prior to contacting it with the reaction mixture.

The term “metal and/or metalloid compound” may be understood to refer to an inorganic or organometallic compound comprising a metal or a metalloid. The metal and/or metalloid may be aluminium, antimony, arsenic, astatine, barium, beryllium, bismuth, boron, cadmium, caesium, calcium, cerium, chromium, cobalt, copper, dysprosium, erbium, europium, gadolinium, gallium, germanium, gold, hafnium, holmium, indium, iridium, iron, lanthanum, lead, lithium, lutetium, magnesium, manganese, mercury, molybdenum, neodymium, nickel, niobium, osmium, palladium, platinum, polonium, potassium, praseodymium, rhenium, rhodium, rubidium, ruthenium, samarium, scandium, selenium, silicon, silver, sodium, tantalum, tellurium, terbium, thorium, thulium, tin, titanium, tungsten, uranium, vanadium, ytterbium, yttrium, zinc and/or zirconium. In some embodiments, the metal and/or metalloid compound only comprises one type of metal and/or metalloid. In alternative embodiments, the metal and/or metalloid compound may comprise two or more different metals and/or metalloids.

The metal and/or metalloid compound may comprise oxygen, nitrogen, phosphorous, a halogen, sulphur, selenium, carbon and/or hydrogen. The oxygen may be in the form of an oxide group (0), combined with hydrogen to provide a hydroxide group (OH), combined with nitrogen to provide a nitrate group or combined with phosphorous to provide a phosphate group. The halogen may be fluorine, chlorine, iodine or bromine. The sulphur may be in the form of a sulphide (S) or combined with oxygen to provide a sulphate (SO₄). The carbon may be combined with oxygen in the form of a carbonate group (CO₃). Accordingly, the metal and/or metalloid compound may be a metal and/or metalloid oxide, metal and/or metalloid halide, metal and/or metalloid sulphide, metal and/or metalloid selenide, metal and/or metalloid sulphate, metal and/or metalloid carbonate, a metal and/or metalloid salt of an inorganic or organic acid, a metal and/or metalloid hydroxide or a metal and/or metalloid compound with a complex structure, an organometallic-compound containing different anions or a salt or solvate thereof.

In some embodiments, the metal and/or metalloid compound is zinc chloride hydroxide monohydrate, zinc hydroxide, zinc oxide, iron oxide or dicopper chloride trihydroxide.

The metal and/or metalloid compound may define a nanoparticle, a microparticle or a film. The nanoparticle, microparticle and/or film may be monodisperse and/or ordered.

A “nanoparticle” may be understood to be a particle where at least one dimension is 999 nanometres or less. Preferably, at least one dimension is 750 nanometres or less, 500 nanometres or less, 250 nanometres or less or wo nanometres or less.

The metal and/or metalloid compound may define a one-dimensional (1D), two-dimensional (2D) or a three-dimensional (3D) nanoparticle. A 1D nanoparticle may be a nano-rod, a nano-wire, a nano-needle, a nano-helix, a nano-springs, a nano-ring, a nano-ribbon, a nano-tube, a nano-belt, or a nano-comb. A 2D particle may be a nano-sheet, a nano-plate, or a nano-pellet. A 3D nanoparticle may be a nano-sphere, a nano-spheroid, a nano-cube, a nano-pyramid, a nano-bipyramid, a nano-dandelion, a nano-snowflake, a nano-octahedron, a nano-truncated cube, a nano-cuboctahedron, a nano-truncated octahedron or a nano-coniferous urchin-like, higher structural object, such as a hyper-branched nano-rod.

A “microparticle” may be as a particle where all dimensions are greater than wo nanometres, greater than 250 nanometre, greater than 500 nanometres, greater than 750 nanometres. In some embodiments, a microparticle is a particle where all dimensions are greater or equal to 1 μm. A “microparticle” may be understood be a particle where at least one dimension is 999 μm or less.

The metal and/or metalloid compound can be produced either attached or unattached to a surface of a solid substrate.

A film may be a material comprising at least one layer disposed across a solid substrate. The film may consist of a single layer or comprise a plurality of layers. The film may define a thickness from nanometre to macro.

The metal and/or metalloid source may define the solid substrate. The metal and/or metalloid compound can be crystalline or amorphous.

The term “oxidising agent” may be understood to refer a substance capable of removing electrons from other reactants during a redox reaction, thus acting as an electron acceptor. Alternatively, or additionally, an oxidizing agent may be viewed as being capable of transferring an electronegative atom to a substance. The electronegative atom may be oxygen. The substance may be the metal and/or metalloid source. The oxidising agent may comprise or consist of water, hydrogen peroxide, ozone, oxygen, a halogen (e.g. fluorine, chlorine, iodine or bromine), potassium nitrate and/or a mineral acid. A mineral acid may comprise sulphuric acid and/or nitric acid. The oxidising agent can be in any physical state (i.e. solid, gas, liquid or in a solution) and can be miscible, partially miscible or immiscible with the ionic liquid. In some embodiments, the oxidising agent is water.

Hydrogen gas may be produced by the method as a co-product. In particular, hydrogen may be generated when the oxidising agent is or comprises water. The method may comprise collecting the hydrogen gas. It will be appreciated that collecting is another word for capturing. The hydrogen gas may be stored and/or used in further applications. It will be appreciated that multiple applications use hydrogen gas, such as energy production. Accordingly, the production of hydrogen gas as a co-product could be beneficial.

An ionic liquid may be understood to be a composition consisting of a cation and an anion. The ionic liquid may have a melting point of less than 350° C., less than 300° C., less than 250° C., less 200° C. or less than 150° C., more preferably less than 100° C., less than 50° C., or less than 25° C. The ionic liquid may have a melting point between −300° C. and 350° C., between −250° C. and 300° C., between −200° C. and 250° C., between −150° C. and 200° C. or between −100° C. and 150° C., more preferably between −50° C. and 100° C. In one embodiment, the ionic liquid has a melting point between 0° C. and 100° C., between 25° C. and 90° C., between 50° C. and 85° C. or between 65° C. and 75° C. In an alternative embodiment, the ionic liquid has a melting point between −25° C. and 50° C. or between 0° C. and 25° C.

The cation may be a molecule comprising a positively charged atom. The positively charged atom may be a nitrogen (N), phosphorous (P) or sulphur (S). The cation may be an organic or inorganic molecule or atom.

In some embodiments, the cation is a positively charged metallic cation.

In some embodiments, the cation is an optionally substituted positively charged 3 to 15 membered heterocyclic ring or an optionally substituted positively charged 5 to 15 membered heteroaromatic ring. Preferably, the cation is an optionally substituted positively charged 4 to 8 membered heterocyclic ring or an optionally substituted positively charged 5 to 8 membered heteroaromatic ring, wherein the heterocyclic ring or the heteroaromatic ring comprises one or more nitrogen atoms. More preferably, the cation is an optionally substituted positively charged 5 to 6 membered heterocyclic ring or an optionally substituted positively charged 5 to 6 membered heteroaromatic ring, wherein the heterocyclic ring or the heteroaromatic ring comprises one or more nitrogen atoms. Preferably, one of the nitrogen atoms is positively charged.

In some embodiments, the cation is:

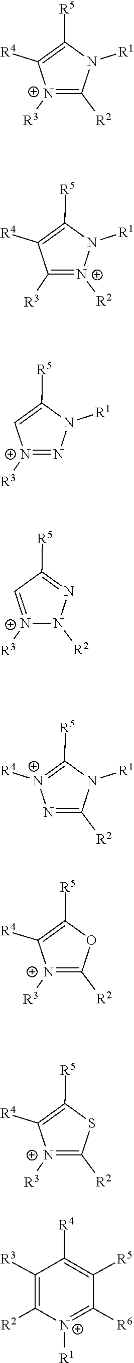

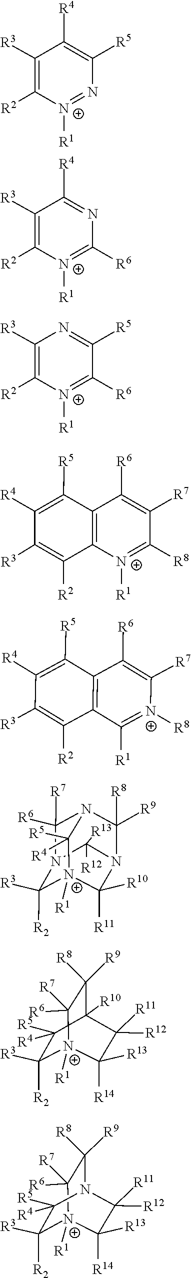

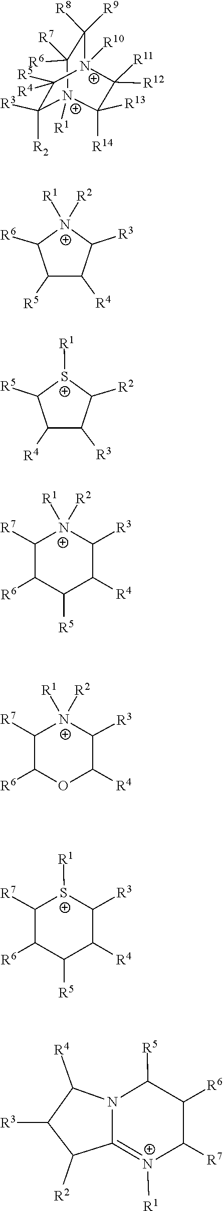

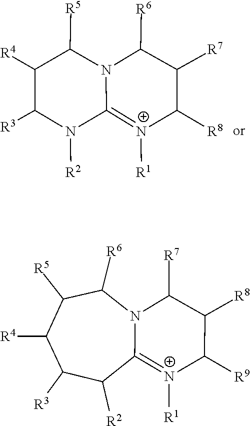

wherein R¹ to R¹⁴ are independently H, an optionally substituted C₁₋₂₄ alkyl, an optionally substituted C₂₋₂₄ alkenyl, an optionally substituted C₂₋₂₄ alkynyl, an optionally substituted C₃₋₂₄ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO², —Cl, —Br, —F, or —I, or two of R¹ to R¹⁴, together with the atoms to which they are attached, form an optionally substituted 3 to 15 membered ring, wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

The optionally substituted 3 to 15 membered ring formed by two of R¹ to R¹⁴, together with the atoms to which they are attached, may be an optionally substituted C₃₋₁₅ cycloalkyl, an optionally substituted 3 to 15 membered heterocycle, an optionally substituted 5 to 15 member heteroatomatic or an optionally substituted C₆₋₁₂ aryl.

In a preferred embodiment, the cation is:

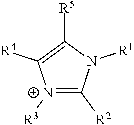

R¹ to R⁵ may be H, an optionally substituted C₁₋₂₄ alkyl, an optionally substituted C₂₋₂₄ alkenyl or an optionally substituted C₂₋₂₄ alkynyl. More preferably, R¹ to R⁵ are H, an optionally substituted C₁₋₁₂ alkyl, an optionally substituted C₂₋₁₂ alkenyl or an optionally substituted C₂₋₁₂ alkynyl. Most preferably, R¹ to R⁵ are H, an optionally substituted C₁₋₆ alkyl, an optionally substituted C₂₋₆ alkenyl or an optionally substituted C₂₋₆ alkynyl. R¹ may be methyl. R² may be H. R³ may be n-butyl or hydrogen. R⁴ may be H. R⁵ may be H. Accordingly, the cation may be 1-butyl-3-methylimidazolium or 1-methylimidazolium.

In an alternative embodiment, the cation is:

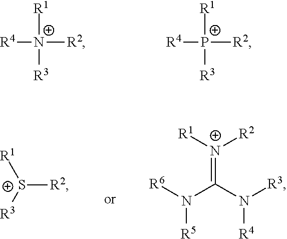

wherein R¹ to R⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO², —Cl, —Br, —F or —I, or two of R¹ to R⁶, together with the atoms to which they are attached, form an optionally substituted 3 to membered ring wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

The cation may be:

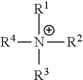

R¹ to R⁴ may be H, an optionally substituted C₁₋₂₄ alkyl, an optionally substituted C₂₋₂₄ alkenyl or an optionally substituted C₂₋₂₄ alkynyl. More preferably, R¹ to R⁴ are H, an optionally substituted C₁₋₁₂ alkyl, an optionally substituted C₂₋₁₂ alkenyl or an optionally substituted C₂₋₁₂ alkynyl. Most preferably, R¹ to R⁴ are H, an optionally substituted C₁₋₆ alkyl, an optionally substituted C₂₋₆ alkenyl or an optionally substituted C₂₋₆ alkynyl. R¹ may be butyl. R² may be methyl. R³ may be methyl. R⁴ may be H. Accordingly, the cation may be —N,N-dimethylbutylammonium.

The anion may be a halide or a molecule comprising a negatively charged atom or a delocalised negative charge. The molecule may be an organic or inorganic molecule.

Accordingly, the anion may be F⁻, Cl⁻, Br⁻, I⁻, ClO₄⁻, BrO₄⁻, NO₃⁻, NC⁻, NCS⁻, NCSe⁻,

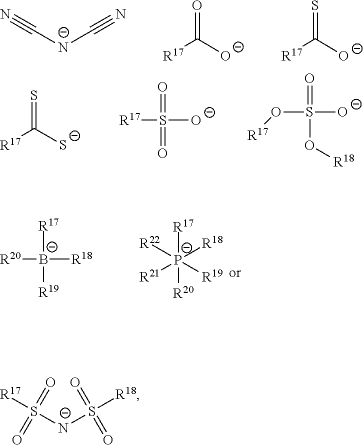

wherein R¹⁷ to R²² are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO², —Cl, —Br, —F or —I, or two of R¹⁷ to R²², together with the atoms to which they are attached, form an optionally substituted 3 to 15 membered ring, wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

The optionally substituted 3 to 15 membered ring formed by two of R¹⁷ to R²², together with the atoms to which they are attached, may be an optionally substituted C₃₋₁₅ cycloalkyl, an optionally substituted 3 to 15 membered heterocycle, an optionally substituted 5 to 15 member heteroatomatic or an optionally substituted C₆₋₁₂ aryl.

In some embodiments, the anion is F⁻, Cl⁻, Br⁻ or I⁻. The anion may be Cl⁻.

In some embodiments, the anion is:

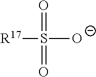

R¹⁷ may be H, an optionally substituted C₁₋₁₂ alkyl, an optionally substituted C₂₋₁₂ alkenyl, an optionally substituted C₂₋₁₂ alkynyl, an optionally substituted C₃₋₆ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵ or —NO². R¹⁷ may be —OR¹⁵ or —SR¹⁵. Preferably, R¹⁷ is —OR¹⁵. R¹⁵ may be H, an optionally substituted C₁₋₁₂ alkyl, an optionally substituted C₂₋₁₂ alkenyl, an optionally substituted C₂₋₁₂ alkynyl. Preferably, R¹⁵ is H.

Alternatively, the anion may be:

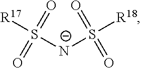

R¹⁷ and R¹⁸ may independently be H, an optionally substituted C₁₋₁₂ alkyl, an optionally substituted C₂₋₁₂ alkenyl, an optionally substituted C₂₋₁₂ alkynyl, an optionally substituted C₃₋₆ cycloalkyl, an optionally substituted C₆₋₁₂ aryl-Cl, —Br, —F or —I. R¹⁷ and R¹⁸ may independently be H, an optionally substituted C₁₋₆ alkyl, an optionally substituted C₂₋₆ alkenyl or an optionally substituted C₂₋₆ alkynyl, Preferably, R¹⁷ and R¹⁸ are independently an optionally substituted C₁₋₃ alkyl, and most preferably R¹⁷ and R¹⁸ are each an optionally substituted methyl. The alkyl, alkenyl and-or alkynyl are preferably substituted with one or more halogen, preferably fluorine. Accordingly, R¹⁷ and R¹⁸ may each be CF₃.

In some embodiments, the anion is tetrafluoroborate, bis(trifluoromethanesulfonyl)amide, bis(fluorosulfonyl)imide, bis(oxalate)borate, trifluoroacetate, trifluoromethanesulfonate or p-tosylate.

The anion may be a negatively charged metal complex. For instance, the anion may be a metal-halide complex. Preferably a metal tetrahalide complex, such as an aluminium tetrahalide complex, an iron tetrahalide complex and/or a zinc tetrahalide complex.

The metal-halide complex may be tetrachloroaluminate, tetrachloroferrate, bromotrichloroferrate, tetrachlorozincate dianion or dibromodichlorozincate dianion.

Accordingly, the inorganic liquid may be 1-n-butyl-3-methylimidazolium chloride, butyl-dimethylammonium hydrogen sulphate, 1-n-butyl-3-methylimidazolium bis(trifluoromethylsulfonyl)imide or methylimidazolium chloride.

The term “alkyl” as used herein, unless otherwise specified, refers to an optionally substituted, saturated straight or branched hydrocarbon. The or each optionally substituted alkyl may be an optionally substituted C₁₋₁₂ alkyl or an optionally substituted C₁₋₆ alkyl.

The term “alkenyl”, refers to an optionally substituted, olefinically unsaturated hydrocarbon group which can be unbranched or branched. The or each optionally substituted alkenyl may be an optionally substituted C₂₋₁₂ alkenyl or an optionally substituted C₂₋₆ alkenyl.

The term “alkynyl” refers to an optionally substituted, acetylenically unsaturated hydrocarbon group which can be unbranched or branched. The or each optionally substituted alkynyl may be an optionally substituted C₂₋₁₂ alkynyl or an optionally substituted C₂₋₆ alkynyl.

The or each alkyl, alkenyl and/or alkynyl can be unsubstituted or substituted with one or more of an optionally substituted C₃₋₆ cycloalkyl, an optionally substituted phenyl, oxo, —OR²³, —SR²³, —CN, —NR²³R²⁴, —SO₃R²³, —OSO₃R²³, —COR²³, —COOR²³, —NO², —Cl, —Br, —F or —I, wherein R²³ and R²⁴ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted phenyl.

“Aryl” refers to an optionally substituted, aromatic 6 to 12 membered hydrocarbon group. An optionally substituted aryl may be an optionally substituted phenyl. The aryl can be unsubstituted or substituted with one or more of an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, —OR²³, —SR²³, —CN, —NR²³R²⁴, —SO₃R²³, —OSO₃R²³, —COR²³, —COOR²³, —NO², —Cl, —Br, —F or —I, wherein R²³ and R²⁴ are independently H, an optionally substituted C₁₋₂₄ alkyl, an optionally substituted C₂₋₂₄ alkenyl, an optionally substituted C₂₋₂₄ alkynyl, an optionally substituted C₃₋₂₄ cycloalkyl or an optionally substituted C₆₋₁₂ aryl.

“Cycloalkyl” refers to an optionally substituted, non-aromatic, saturated, partially saturated, monocyclic, bicyclic or polycyclic hydrocarbon membered ring system.

“Heteroaryl” or “heteroaromatic ring” refers to an optionally substituted, monocyclic or bicyclic aromatic ring system in which at least one ring atom is a heteroatom. The or each heteroatom may be independently selected from the group consisting of oxygen, sulfur and nitrogen.

“Heterocycle” or “heterocyclic ring” refers to an optionally substituted, monocyclic, bicyclic or bridged molecules in which at least one ring atom is a heteroatom. The or each heteroatom may be independently selected from the group consisting of oxygen, sulfur and nitrogen.

The or each cycloalkyl, heterocycle/heterocylic ring and/or heteroaryl/heteroaromatic ring can be unsubstituted or substituted with one or more of an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, oxo, —OR²³, —SR²³, —CN, —NR²³R²⁴, —SO₃R²³, —OSO₃R²³, —COR²³, —COOR²³, —NO², —Cl, —Br, —F or —I, wherein R²³ and R²⁴ are independently H, an optionally substituted C₁₋₂₄ alkyl, an optionally substituted C₂₋₂₄ alkenyl, an optionally substituted C₂₋₂₄ alkynyl, an optionally substituted C₃₋₂₄ cycloalkyl or an optionally substituted C₆₋₁₂ aryl.

The method may comprise contacting the metal and/or metalloid source with one of the ionic liquid and the oxidizing agent to form a first mixture and subsequently contacting the first mixture with the other of the ionic liquid and the oxidizing agent to thereby form the reaction mixture and simultaneously contact the metal and/or metalloid source with the reaction mixture.

Alternatively, the method may comprise contacting the ionic liquid and the oxidizing agent, to form the reaction mixture, prior to contacting the reaction mixture and the metal and/or metalloid source.

The reaction mixture may consist of the ionic liquid and the oxidizing agent. Alternatively, the reaction mixture may further comprise one or more additives. The one or more additives may comprise a catalyst, a stabilizer and/or a molecular solvent.

The molecular solvent may be acetonitrile, dichloromethane, chloroform, tetrahydrofuran (THF), 2-methyltetrahydrofuran (2-MeTHF), methyl tert-butyl ether (TBME), an amine (e.g. trimethylamine or pyridine), toluene, heptane, dimethyl sulfoxide (DMSO), sulpholane, N,N′-dimethylpropyleneurea (DMPU), an alcohol (e.g. i-butanol, i-amyl alcohol or 1,2-propanediol, glycerol), an ester (e.g. 1-butyl acetate, i-amyl acetate, glycol acetate, y-valerolactone or diethylsuccinate), an ether (e.g. tert-amyl methyl ether (TAME), cyclopentyl methyl ether (CPME) or ethyl tert-butyl ether (ETBE)), a hydrocarbon (e.g. d-limonene, turpentine or p-cymene), a dipolar aprotic solvent (e.g. dimethyl carbonate, ethylene carbonate propylene carbonate or cyrene), ethyl lactate, an organic acid (e.g. acetic acid, lactic acid or tetrahydrofolic acid (THFA)), a ketone (e.g. acetone, methylethyl ketone or methyl isobutyl ketone (MIBK)), an alkoxy amine, an amide (e.g. N-methyl-2-pyrrolidone (NMP)) or a combination thereof.

The stabilizing agent may be a long chain alkyl surfactants, such as a long chain alkyl carboxylate acid, a long chain alkyl amine and or a polymer. Accordingly, the stabilizing agent may be COOR²⁵, P(O)(OH)R²⁵R²⁶, P(O)R²⁵R²⁶R²⁷, NR²⁵R²⁶R²⁷, XNR²⁵R²⁶R²⁷R²⁸, R²⁵⁰H or a polymer wherein R²⁵ is an optionally substituted C₅₋₅₀ alkyl, an optionally substituted C₅₋₅₀ alkenyl or an optionally substituted C₅₋₅₀ alkynyl, R²⁶ to R²⁸ is independently H, an optionally substituted C₁₋₂₄ alkyl, an optionally substituted C₁₋₂₄ alkenyl or an optionally substituted C₁₋₂₄ alkynyl and X is a halide. R²⁵ may be an optionally substituted C₁₀₋₃₀ alkyl, an optionally substituted C₁₀₋₃₀ alkenyl or an optionally substituted C₁₀₋₃₀ alkynyl. Accordingly the stabilizing agent may be oleic acid, bis-(2,4,4-trimethylpentyl)phosphinic acid, stearic acid, oleylamine, hexadecylamine, 1,2-hexadecanediol, cetyltrimethylammonium bromide, N,N-dimethlylhexadecyl amine, tri-n-octylphosphine oxide, ethylene glycol or poly(vinylpyrrolidone).

The reaction mixture may comprise or consist of the ionic liquid and the oxidizing agent in a weight ratio of between 1:1,000 and 1,000:1, between 1:750 and 750:1, between 1:500 and 500:1, between 1:250 and 250:1, between 1:100 and 100:1, more preferably between 1:50 and 50:1, between 1:25 and 25:1 or between 1:15 and 15:1, and most preferably between 1:10 and 10:1, between 1:7 and 7:1 or between 1:6 and 5:1. In an embodiment, the reaction mixture may comprise or consist of the ionic liquid and the oxidizing agent in a weight ratio of between 1:10 and 2:1, between 1:8 and 1:1, between 1:6 and 1:2 or between 1:5 and 1:4. In an alternative embodiment, the reaction mixture may comprise or consist of the ionic liquid and the oxidizing agent in a weight ratio of 1:5 and 10:1, between 1:1 and 8:1, between 2:1 and 6:1 or between 3:1 and 4:1. In a further alternative embodiment, the reaction mixture may comprise or consist of the ionic liquid and the oxidizing agent in a weight ratio of between 1:10 and 5:1, between 1:5 and 2:1 or between 1:2 and 1:1.

The reaction mixture may comprise or consist of the ionic liquid and the oxidizing agent in a molar ratio of between 1:1,000 and 100:1, more preferably between 1:500 and 50:1, between 1:250 and 10:1 or between 1:100 and 5:1, and most preferably between 1:80 and 3:1, between 1:70 and 2:1, between 1:60 and 1:1 or between 1:50 and 1:2. In an embodiment, the reaction mixture may comprise or consist of the ionic liquid and the oxidizing agent in a molar ratio of between 1:100 and 1:5, between 1:90 and 1:10, between 1:80 and 1:20, between 1:70 and 1:30, between 1:60 and 1:40 or between 1:55 and 1:45. In an alternative embodiment, the reaction mixture may comprise or consist of the ionic liquid and the oxidizing agent in a molar ratio of between 1:50 and 4:4 between 1:40 and 3:1, between 1:20 and 2:1, between 1:10 and 1:1, between 1:5 and 1:2 or between 1:4 and 1:3. In a further alternative embodiment, the reaction mixture may comprise or consist of the ionic liquid and the oxidizing agent in a molar ratio of between 1:50 and 1:4, between 1:40 and 1:6, between 1:30 and 1:8, between 1:20 and 1:10 or between 1:18 and 1:13.

The metal and/or metalloid source and the reaction mixture may be provided in a weight ratio of between 1:100 and 100:1, between 1:80 and 80:1, between 1:50 and 50:1, between 1:20 and 20:1, between 1:10 and 10:1, between 1:5 and 5:1 or between 1:2 and 2:1.

The metal and/or metalloid source and the reaction mixture may be contacted at a temperature between −50° C. and 500° C., more preferably between −25° C. and 400° C. or between 0° C. and 300° C., and most preferably between 5° C. and 200° C. or between 10° C. and 175° C. In one embodiment, the metal and/or metalloid source and the reaction mixture are contacted at a temperature between 25° C. and 200° C., between 50° C. and 190° C., between 100° C. and 180° C., between 125° C. and 170° C. or between 140° C. and 160° C. In an alternative embodiment, the metal and/or metalloid source and the reaction mixture are contacted at a temperature between 25° C. and 200° C., between 50° C. and 190° C., between 75° C. and 180° C., between 100° C. and 150° C. or between 110° C. and 130° C. In a further alternative embodiment, the metal and/or metalloid source and the reaction mixture are contacted at a temperature between 20° C. and 150° C., between 40° C. and 100° C. or between 60° C. and 80° C. In a still further alternative embodiment, the metal and/or metalloid source and the reaction mixture are contacted at a temperature between 0° C. and 150° C., between 10° C. and 100° C., between 20° C. and 75° C. or between 30° C. and 50° C. In a still further embodiment, the metal and/or metalloid source and the reaction mixture are contacted at a temperature between 0° C. and 100° C., between 5° C. and 50° C., between 10° C. and 30° C. or between 15° C. and 25° C.

The metal and/or metalloid source and the reaction mixture may be contacted at a pressure between 1 kPa and 100,000 kPa, between 10 kPa and 10,000 kPa, between 20 kPa and 1,000 kPa, between 40 kPa and 500 kPa, between 60 kPa and 250 kPa, between 80 kPa and 150 kPa, between 90 kPa and no kPa or between 95 kPa and 105 kPa. The metal and/or metalloid source and the reaction mixture may be contacted under atmospheric pressure. It may be appreciated that atmospheric pressure is 101.325 kPa.

The metal and/or metalloid source and the reaction mixture may be contacted for at least 1 minute, at least 15 minutes, at least 30 minutes, at least 1 hour, at least 6 hours, at least 12 hours, at least 24 hours or at least 48 hours. In some embodiments, the metal and/or metalloid source and the reaction mixture are contacted for at least 3 days, at least 5 days, at least 7.5 days, at least 10 days, at least 15 days, at least 20 days, at least 25 days, at least 30 days, at least 40 days, at least 50 days or at least 60 days.

The metal and/or metalloid source and the reaction mixture may be contacted for between 1 minute and 500 days, between 1 hour and 200 days, between 12 hours and 100 days, between 24 hours and 80 days or between 48 hours and 70 days. In some embodiments, the metal and/or metalloid source and the reaction mixture are contacted for between 1 minute and 25 days, between 1 hour and 10 days, between 3 hours and 5 days, between 6 hours and 4 days, between 8 hours and 2 days or between 12 hours and 36 hours. In some embodiments, the metal and/or metalloid source and the reaction mixture are contacted for between 1 day and 50 days, between 2 days and 30 days, between 3 days and 20 days or between 4 days and 10 days. In alternative embodiments, the metal and/or metalloid source and the reaction mixture are contacted for between 30 days and 100 days or between 40 days and 70 days.

The metal and/or metalloid source is preferably a solid. The reaction mixture is preferably a liquid. The ratio of the surface area of the metal and/or metalloid source to the liquid volume of the reaction mixture may be between 0.001 and 100 ml/mm², between 0.01 and 10 ml/mm², between 0.05 and 1 ml/mm², between 0.1 and 0.5 ml/mm² or between 0.15 and 0.3 ml/mm².

The method may comprise separating the metal and/or metalloid compound from the ionic liquid. The metal and/or metalloid compound may be separated from the ionic liquid by filtration and/or centrifugation. Depending upon the size of the metal and/or metalloid compound, the method could comprise using conventional filtration, ultra filtration or nano filtration.

Particles formed on a solid have low solubility in the ionic liquid-oxidant phase. Additionally, the oxidising agent is consumed and transferred into the solid phase during the reaction. Accordingly, the ionic liquid phase may be predominantly free from impurities. Thus it is possible to easily reuse the ionic liquid phase. Ionic liquid recycled from the reactions described herein retain the thermal and chemical stability characteristics of unrecycled, new ionic liquid. Moreover, it is possible to continue to reuse the ionic liquid through multiple batches of the reactions described herein. For example, the reactions described herein can be repeated one, two, three, four, five or more times with the original ionic liquid.

Accordingly, the method may comprise purifying the ionic liquid after separation. In various exemplary embodiments, the separated ionic liquid may be purified by passing the ionic liquid through a column of an absorbent material, such as, for example, an alumina, activated carbon, zeolites or silica gel. Also, volatile impurities can be removed from the separated ionic liquid by heating. Such heating can be conducted under a vacuum or at atmospheric pressure, and may be conducted in air or under an inert gas, such as nitrogen or argon. Metallic impurities could be removed by electrodeposition. Metallic impurities that may be generated from the metal and/or metalloid source may also be removed by chemical or electrochemical methods, for example, liquid-liquid extraction with or without chelating agents, selective crystallization by lowering the temperature of the reaction mixtures, electrodeposition in electrowinning cells or precipitation with chemical agents.

The method may comprise heating the metal and/or metalloid compound to cause the metal and/or metalloid compound to chemically react and provide a further metal and/or metalloid compound. The method may comprise heating the metal and/or metalloid compound subsequent to separating the metal and/or metalloid compound from the reaction mixture. The method may comprise heating the metal and/or metalloid compound in air or oxygen. The method may comprise heating the metal and/or metalloid compound at a temperature of at least 50° C., at least 100° C., at least 200° C., at least 300° C., at least 400° C. or at least 450° C. The method may comprise heating the metal and/or metalloid compound at a temperature between 50° C. and 1000° C., between 100° C. and 900° C., between 200° C. and 800° C., between 300° C. and 700° C., between 400° C. and 600° C. or between 450° C. and 550° C. In this embodiment, the metal and/or metalloid compound may comprise a hydroxide group and/or a halide. The further metal and/or metalloid compound may be a metal oxide or a metalloid oxide.

The method may be conducted as a batch process. Alternatively, the method may be conducted as a continuous or semi-continuous process. For instance, where the method is conducted as a continuous process an ionic liquid, an oxidising agent and a metal and/or metalloid source can be constantly be introduced into a reactor.

The inventors note that the method of the first aspect may be used to produce novel compounds.

In accordance with a second aspect, there is provided a cupro-zinc-oxo-chloride complex.

The complex may consist of copper, zinc, oxygen and chlorine.

The complex may comprise between 1 and 75 at. % copper, more preferably between 2 and 50 at. % or between 5 and 45 at. % copper, and most preferably between 10 and 40 at. %, between 20 and 35 at. % or between 25 and 30 at. % copper.

The complex may comprise between 0.1 and 20 at. % zinc, more preferably between 0.5 and 10 at. % or between 1 and 5 at. % zinc, and most preferably between 1.5 and 4 at. % or between 2 and 3 at. % zinc.

The complex may comprise between 5 and 90 at. % oxygen, more preferably between 10 and 85 at. % or between 20 and 80 at. % oxygen, and most preferably between 40 and 75 at. %, between 50 and 70 at. % or between 60 and 65 at. % oxygen.

The complex may comprise between 0.1 and 30 at. % chlorine, more preferably between 0.5 and 20 at. % or between 1 and 10 at. % chlorine, and most preferably between 2 and 8 at. %, between 3 and 7 at. % or between 4 and 6 at. % chlorine.

The complex may have an energy dispersive x-ray (EDX) spectrum substantially as shown in FIG. 13.

All features described herein (including any accompanying claims, abstract and drawings), and/or all of the steps of any method or process so disclosed, may be combined with any of the above aspects in any combination, except combinations where at least some of such features and/or steps are mutually exclusive.

### DESCRIPTION OF DRAWINGS

For a better understanding of the invention, and to show how embodiments of the same may be carried into effect, reference will now be made, by way of example, to the accompanying drawings, in which:—

FIG. 1 is a scanning electron microscope (SEM) image of a zinc substrate exposed to 1-butyl-3-methylimidazolium chloride (XH₂O=0.98 solution at 70±1° C.), showing ZnO nanorods after 4 d exposure (average size 90±40 nm);

FIG. 2 is an SEM image of a zinc substrate after exposure to 1-butyl-3-methylimidazolium chloride (XH₂O=0.75 solution, 20±1° C.) for 26 d, showing the top of hexagonal nanorods (average size 150±30 nm);

FIG. 3 is an SEM image of zinc substrate after exposure to 1-butyl-3-methylimidazolium chloride (XH₂O=0.75 solution, 20±1° C.) for 15 d, showing zinc chloride hydroxide monohydrate (Zn5(OH)₈Cl₂·H₂O) crystal plates. Estimated thickness 2.5±1.5 m and diameter 19±8 μm;

FIG. 4 is an SEM image showing zinc substrate exposed to 1-butyl-3-methylimidazolium chloride (XH₂O=0.98 solution at 20±1° C.) showing multiple Zn(OH)₂ octahedrons after 44 d exposure with a mean length of 21±6 μm;

FIGS. 5A and B are SEM images of ε-Zn(OH)₂ octahedrons and Zn₅(OH)₈Cl₂·H₂O (ZHC) particles, respectively, before calcination; FIG. 5C is an x-ray diffraction (XRD) spectra of the mixture Zn(OH)₂ and ZHC powder, showing signals from both compounds, main peaks form diffraction patterns have been labelled: (x) ZHC and (+) ε-Zn(OH)₂; FIGS. 5D and 5E are SEM images of ε-Zn(OH)₂ octahedrons and ZHC particles, respectively, after calcination; and FIG. 5F is an XRD spectra of the calcinated samples showing only signals from ZnO, main peaks have been abelled (⇒) ZnO;

FIG. 6 is a summary of the most represented structures obtained when a zinc substrate was exposure to a 1-butyl-3-methylimidazolium chloride solution;

FIG. 7 is an SEM image of a brass substrate after exposure to 1-butyl-3-methylimidazolium chloride (XH₂O=0.98 solution, 20±1° C.) for 18 d, showing the top of hexagonal nanorods (average size to ±0.2 μM);

FIG. 8 is an SEM image of an iron substrate after exposure to 1-butyl-3-methylimidazolium chloride (XH₂O=0.98 solution, 70±1° C.) for 8 d, showing the formation of 500±100 nm Fe₂O₃ cubes and 4±1 μm cuboctahedra structures;

FIG. 9 is an SEM image of an iron substrate after exposure to 1-butyl-3-methylimidazolium chloride (XH₂O=0.98 solution, 70±1° C.) for 3.5 d, showing the formation of 115±5 nm diameter hexagonal Iron oxide plates;

FIG. 10 is an SEM image of a copper substrate after exposure to 1-butyl-3-methylimidazolium chloride (XH₂O=0.98 solution, 70±1° C.) for 15 d, showing the formation of dicopper chloride trihydroxide Cu₂(OH)₃Cl crystals with an average edge size of 1.7±0.5 μm;

FIG. 11 is an SEM image of a zinc substrate after exposure to 1-butyl-3-methylimidazolium chloride (water content 60 wt %, 40±1° C., pH=3, mass ratio 1:1 stirring rate 250 rpm) for 7 d showing the formation of ZnO nanorods with an average length of 900±100 nm;

FIG. 12 is an SEM image of a brass substrate after exposure to 1-butyl-3-methylimidazolium chloride (water content 98 mol %, room temperature) for 18 d showing the formation of a cupro-zinc-oxo-chloride complex acicular crystals radiating from a core; and

FIG. 13 is an energy dispersive x-ray (EDX) spectrum of the cupro-zinc-oxo-chloride complex of FIG. 12.

### EXAMPLES

### Example 1—Synthesis of 90 nm Diameter Hexagonal Zinc Oxide (ZnO) Nanorods on Zinc Substrate by Direct Oxidation of Zn in 1-butyl-3-methylimidazolium Chloride

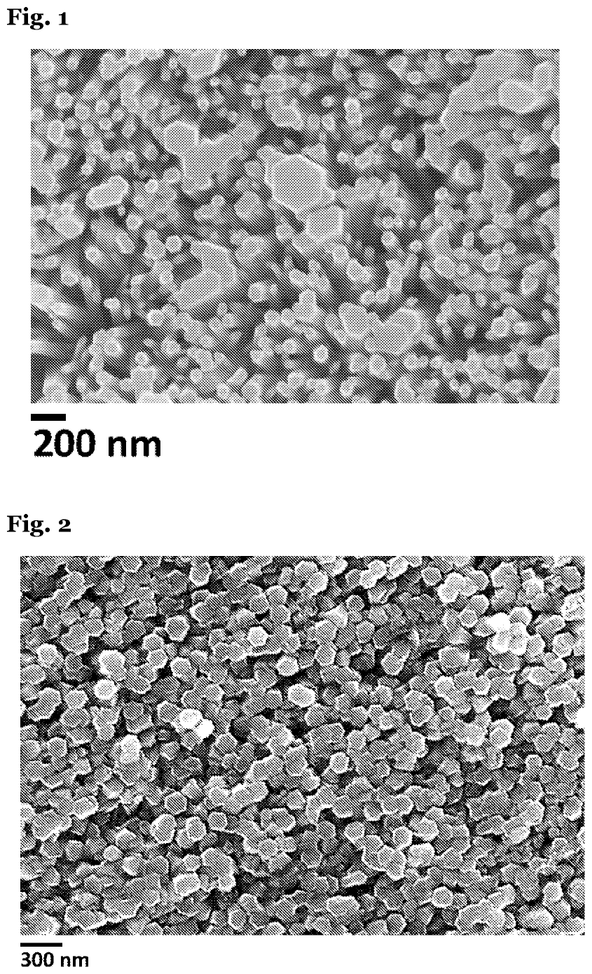

A disk of zinc (purity >99.95%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol % (82 wt %), pre-heated to 70° C., with the help of a fluorocarbon filament. The metallic surface area to liquid volume ratio was 0.2 mL mm⁻². The container with the solution and the suspended metal substrate was placed in a convection oven at 70° C. for 4 days. At the conclusion of the experiment, the substrate was removed from the solvent and quenched in demineralized water, then washed, with demineralized water, industrial methylated spirits, and acetone. This yielded to the formation of hexagonal zinc oxide (flat-top) of average size 90±40 nm as depicted in FIG. 1.

### Example 2—Synthesis of 150 nm Diameter Hexagonal Zinc Oxide Nanorods on Zinc Substrate by Direct Oxidation of Zn in 1-butyl-3-methylimidazolium Chloride

A disk of zinc (purity >99.95%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 75 mol %, pre-heated to 70° C., with the help of a fluorocarbon filament. The metallic surface area to liquid volume ratio was 0.2 mL mm⁻². The container with the solution and the suspended metal substrate was placed in a convection oven at 20° C. for 26 days. At the conclusion of the experiment, the substrate was removed from the solvent and quenched in demineralized water, then washed, with demineralized water, industrial methylated spirits, and acetone. This yielded to the formation of hexagonal zinc oxide (flat-top) of average size 150±30 nm as depicted in FIG. 2.

### Example 3—Synthesis of Zinc Chloride Hydroxide Monohydrate (Zn₅(OH)₈Cl₂·H₂O Plates by Direct Oxidation of Zn in 1-butyl-3-methylimidazolium Chloride

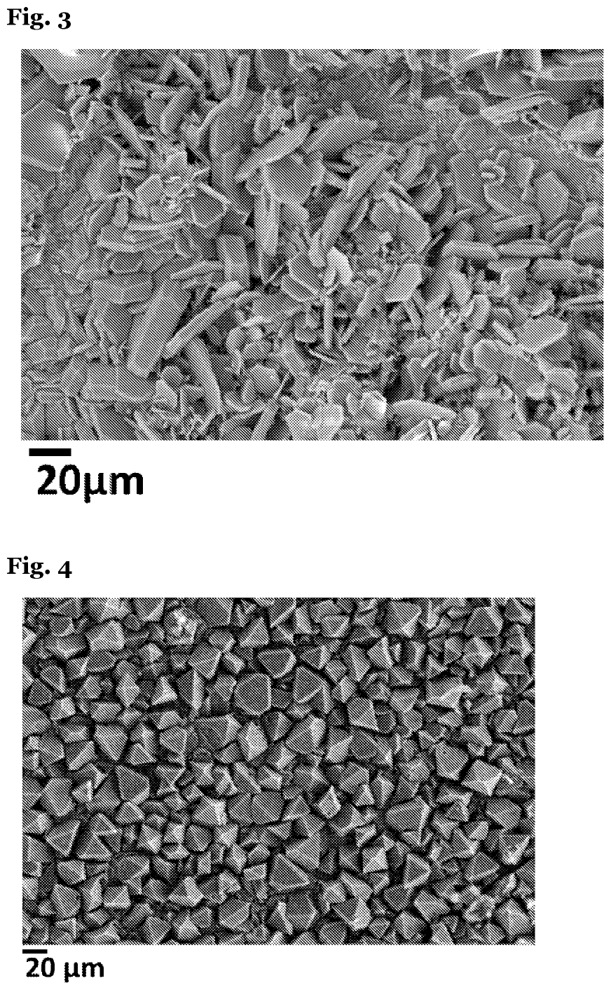

A disk of zinc (purity >99.95%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, pre-heated to 70° C., with the help of a fluorocarbon filament. The metallic surface area to liquid volume ratio was 0.2 mL mm⁻². The container with the solution and the suspended metal substrate was placed in a convection oven at 70° C. for 15 days. At the conclusion of the experiment, the substrate was removed from the solvent and quenched in demineralized water, then washed, with demineralized water, industrial methylated spirits, and acetone. This yielded to the formation of various structures, such as zinc chloride hydroxide monohydrate (Zn₅(OH)₈Cl₂·H₂O) plate-like crystals of with an average thickness of 2.5 μm and average size of 19 μm as depicted in FIG. 3.

### Example 4—Synthesis of Zinc Hydroxide (Zn(OH)₂) Octahedrons by Direct Oxidation of Zn in 1-butyl-3-methylimidazolium Chloride Solutions

A disk of zinc (purity >99.95%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, at room temperature, with the help of a fluorocarbon filament, for 44 d. The metallic surface area to liquid volume ratio was 0.2 mL mm⁻². At the conclusion of the experiment, the substrate was removed from the solvent and washed with demineralized water, industrial methylated spirits, and acetone. This yielded to the formation of various structures, such as zinc hydroxide (Zn(OH)₂) octahedrons crystals of with an average edge size of 21±6 μm as depicted in FIG. 4.

### Example 5—Synthesis of ZnO Structures Through Calcination of Zinc Chloride Hydroxide Monohydrate (Zn₅(OH)₈Cl₂·H₂O) Plate-Like Crystals and Zinc Hydroxide (Zn(OH)₂) Octahedrons Though Calcination of Samples Obtained by Direction Oxidation of Zinc in 1-butyl-3-methylimidazolium Chloride Solutions

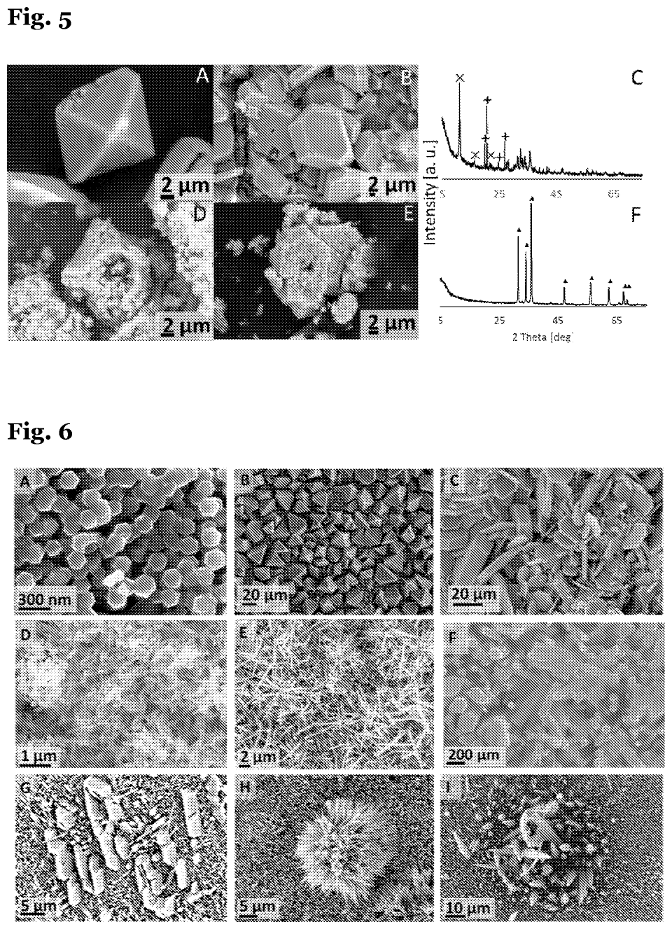

Structures prepared in Examples 4 (Zn(OH)₂ octahedrons along with (Zn₅(OH)₈Cl₂·H₂O) plate-like crystals similar to the ones shown in Example 3) were removed mechanically from the substrate, by scratching the surface, and recovered. The collected powder containing both species was heated in a TGA instrument from ambient temperature to 650° C. at a rate of 5° C./min. The calcination process ended at 550° C. The post-calcination products contained only ZnO, and generally conserved the overall crystal shape of the initial compounds, with an increased porosity. For example, the Zn(OH)₂ octahedrons were converted to ZnO octahedrons and the (Zn₅(OH)₈Cl₂·H₂O) plate-like crystals were converted to ZnO plate-like crystals, as depicted in FIG. 5.

### Example 6—Comparison of Different Conditions

The inventors compared the structures obtained using different reaction conditions, and their findings are provided in Table 1, below. The structures are illustrated in FIG. 6.

TABLE 1
Summary of the must representative structures obtained when a zinc
disk is contacted with 1-butyl-3-methylimidazolium chloride solutions

| | Water | | | | | | | | | | | | |
|---|---|---|---|---|---|---|---|---|---|---|---|---|---|
| IL | Content/mol % | Temp/º C. | Exposure Time | | [A] | [B] | [C] | [D] | [E] | [G] | [F] | [H] | [I] |
| 2 | 75 | 120 | 5.8 | days | X | | | | | | | | X |
| 1 | 75 | 20 | 18/26 | days | X | | | | | | | | |
| 2 | 75 | 120 | 1 | day | X | | | | | | | | |
| 2 | 75 | 120 | 16 | hours | X | | | | | X | | | X |
| 2 | 98 | 20 | 6 | days | | X | | | | | | | |
| 2 | 98 | 20 | 16 | days | | X | | | | | | | |
| 1 | 98 | 20 | 18 | days | X | | | | | | | | |
| 1 | 98 | 20 | 44 | days | | X | X | X | | | | | X |
| 2 | 98 | 20 | 48 | days | | | X | | | | | | |
| 1 | 98 | 70 | 3.5 | days | X | | | | | X | X | X | |
| 1 | 98 | 70 | 15 | days | | | X | X | X | X | | X | X |
| 2 | 98 | 120 | 1 | day | X | | | | | X | | | X |
| 2 | 98 | 120 | 16 | hours | X | | | | | | | | |

The IL for all experiments was 1-butyl-3-methylimidazolium chloride. IL-1 is from Sigma-Aldrich, with a purity of >98%, and IL-2 is from Iolitec, with a purity of >99%.

As shown in FIG. 6, [A] is ZnO flat-topped hexagonal rods, [B] is ε-Zn(OH)₂ octahedrons, [C] is ZHC plates, [D] is ZnO short rods (round and sharp ended), [E] is ZnO needles, [F] flat-topped hexagonal nano-rods, [G] is ZnO thick crystals, [H] is ZnO 3D needle flower, and [I] is ZnO 3D thick crystal flower.

### Example 7—Synthesis of 1 μm Diameter Hexagonal Zinc Oxide (ZnO) Nanorods by Direct Oxidation of Brass in 1-butyl-3-methylimidazolium Chloride

A disk of brass (Cu 63% and Zn 37%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, at room temperature, with the help of a fluorocarbon filament, for 18 d. The metallic surface area to liquid volume ratio was 0.2 mL mm⁻². At the conclusion of the experiment, the substrate was removed from the solvent and washed with demineralized water, industrial methylated spirits, and acetone. This yielded to the formation of various structures, such as zinc hydroxide ZnO hexagonal rods crystals of with an average size of 1.0±0.2 μm as depicted in FIG. 7.

### Example 8—Synthesis of 500 nm Cubes and 4 μm Cuboctahedra Iron Oxide by Direct Oxidation of Iron in 1-butyl-3-methylimidazolium Chloride

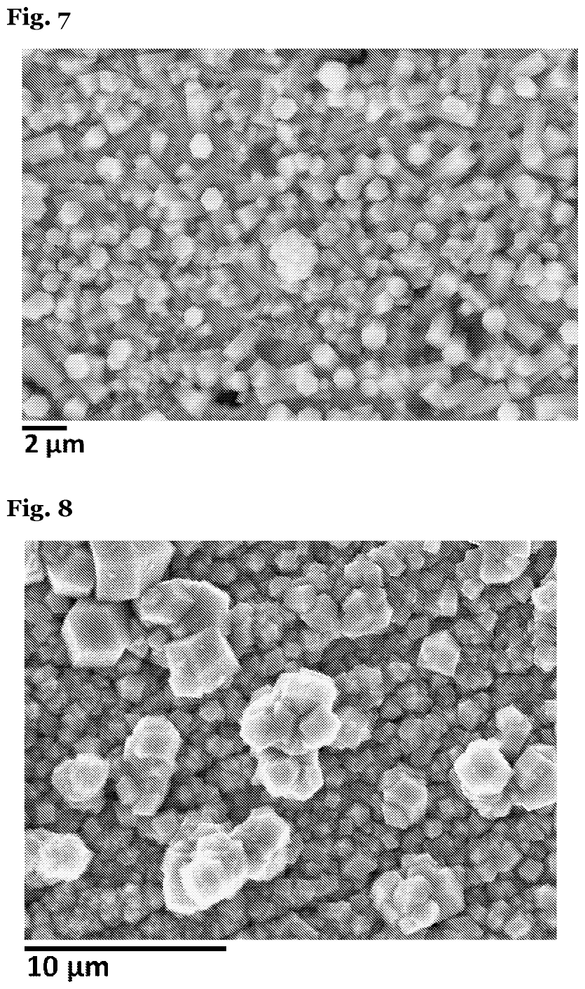

A disk of iron (purity 99.99%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, pre-heated to 70° C., with the help of a fluorocarbon filament. The metallic surface area to liquid volume ratio was 0.2 mL mm⁻². The container with the solution and the suspended metal substrate was placed in a convection oven at 70° C. for 8 days. At the conclusion of the experiment, the substrate was removed from the solvent and quenched in demineralized water, then washed, with demineralized water, industrial methylated spirits, and acetone. This yielded to the formation of 500±100 nm Fe₂O₃ cubes and 4±1 μm cuboctahedra structures as depicted in FIG. 8.

### Example 9—Synthesis of 115 nm Diameter Hexagonal Iron Oxide Plate by Direct Oxidation of Iron in 1-butyl-3-methylimidazolium Chloride

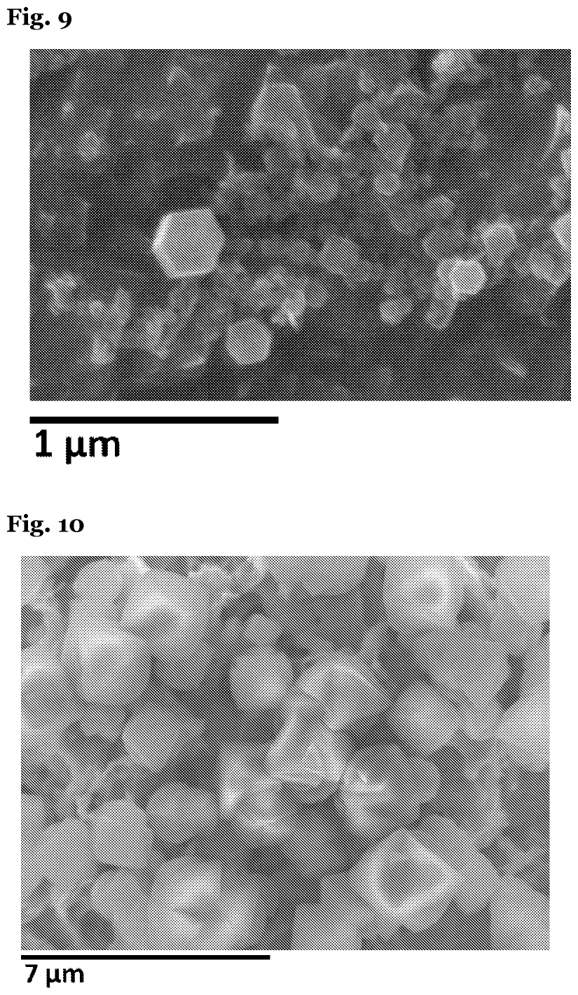

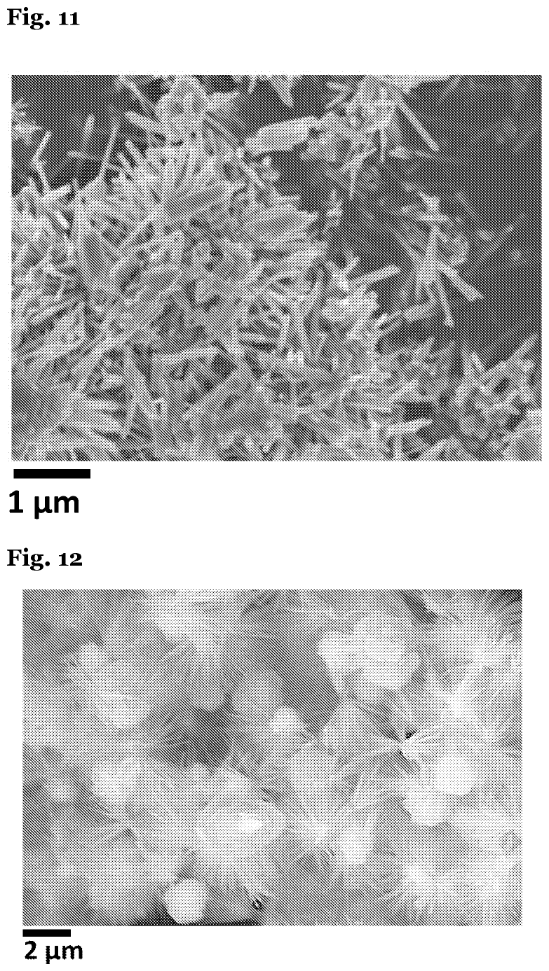

A disk of iron (purity 99.99%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, pre-heated to 70° C., with the help of a fluorocarbon filament. The metallic surface area to liquid volume ratio was 0.2 mL mm⁻². The container with the solution and the suspended metal substrate was placed in a convection over at 70° C. for 3.5 days. At the conclusion of the experiment, the substrate was removed from the solvent and quenched in demineralized water, then washed, with demineralized water, industrial methylated spirits, and acetone. This yielded to the formation of 115±5 nm diameter hexagonal Iron oxide plates as depicted in FIG. 9.

### Example 10—Synthesis of Dicopper Chloride Trihydroxide (Cu₂(OH)₃C₁) by Direct Oxidation of Copper in 1-butyl-3-methylimidazolium Chloride

A disk of copper (purity >99.9%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol %, pre-heated to 70° C., with the help of a fluorocarbon filament. The metallic surface area to liquid volume ratio was 0.2 mL mm⁻². The container with the solution and the suspended metal substrate was placed in a convection over at 70° C. for 15 days. At the conclusion of the experiment, the substrate was removed from the solvent and quenched in demineralized water, then washed, with demineralized water, industrial methylated spirits, and acetone. This yielded to the formation of bi-pyramidal dicopper chloride trihydroxide Cu₂(OH)₃Cl crystals with an average edge size of 1.7±0.5 μm as depicted in FIG. 10.

### Example 11—Synthesis of Zinc Oxide (ZnO) Nanorods by Direct Oxidation of Zinc Granules in 1-butyl-3-methylimidazolium Chloride

The synthesis of zinc oxide nanoparticles was carried out via the oxidation zinc granules (20-30 mesh) in a solution of an aqueous 1-butyl-3-methylimidazolium chloride with a water content of 94 mol % (60 wt %). Upon adjusting the pH, concentrated HCl was added dropwise into deionized water (100 mL) until a pH of 3 was achieved. Subsequently, 1-butyl-3-methylimidazolium chloride was added until concentrations of 60 wt % water was achieved. The 1-butyl-3-methylimidazolium chloride solutions were added to the zinc granules in desiccation tubes in a 1:1 mass ratio. Stirring rate was 250 rpm rotation speeds in an incubator (New Brunswick Scientific, Innova 42 Incubator Shaker Series) and the synthesis carried out over a period of 7 days at 40° C. At the end of the experiment, the zinc oxide product was placed into centrifuge tubes (falcon, 50 mL) and washed using two aliquots of water and one of absolute ethanol, centrifuging for 40 minutes between each washing in order to effectively separate the product from the solution. The ionic liquid was recovered via rotary evaporation. After washing the product was calcinated in a vacuum oven overnight at 150° C. This procedure yielded ZnO nanorods of an average length of 700±200 nm as depicted in Figure ii.

### Example 12—Synthesis of Nickel Based Compounds by Direct Oxidation of Nickel in Butyl-Dimethylammonium Hydrogen Sulphate

A disk of nickel (purity >99.98%, d=18 mm and 0.125 mm thickness) was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in 3 ml butyl-dimethylammonium hydrogen sulphate solution with a water content of 75 mol % (24 wt %), pre-heated to 150° C. The container with the solution and the suspended metal substrate was placed in a convection oven at 150° C. for 48h. At the conclusion of the experiment, the substrate was removed from the solvent and quenched in demineralized water, then washed, with demineralized water, industrial methylated spirits, and acetone. This yielded to the formation of a green solid on the surface of the substrate.

### Example 13—Synthesis of Aluminium Based Compounds by Direct Oxidation of Nickel in Butyl-Dimethylammonium Hydrogen Sulphate

A disk of aluminium (purity >99.999%, d=18 mm and 0.125 mm thickness) was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in 3 ml butyl-dimethylammonium hydrogen sulphate solution with a water content of 75 mol %, pre-heated to 150° C. The container with the solution and the suspended metal substrate was placed in a convection oven at 150° C. for 48h. At the conclusion of the experiment, the substrate was converted into a white solid.

It is noted that this method generates hydrogen gas as a co-product. Without wishing to be bound by theory, the inventors note that there are several reactions that can take place:

2Al+6H₂O→2Al(OH)₃+3H₂

2Al(OH)₃→Al₂O₃+3H₂

Al+2H₂O→AlOOH+1.5H₂

The inventors note that the hydrogen gas could be captured.

### Example 14—Synthesis of Titanium Based Compounds by Direct Oxidation of Nickel in Butyl-Dimethylammonium Hydrogen Sulphate

A washer of titanium (Grade 2, d=18 mm and 0.125 mm thickness) was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in 3 ml butyl-dimethylammonium hydrogen sulphate solution with a water content of 75 mol %, pre-heated to 150° C. The container with the solution and the suspended metal substrate was placed in a convection oven at 150° C. for 48h. At the conclusion of the experiment, the substrate was removed from the solvent and quenched in demineralized water, then washed, with demineralized water, industrial methylated spirits, and acetone. This yielded to the formation of a white solid precipitate in the solution.

### Example 15—Synthesis of Copper(II) Bis(Trifluoromethanesulfonyl)Imide by Direct Oxidation of Copper in 1-Butyl-3-methylimidazolium bis(trifluoromethylsulfonyl)imide

A disk of copper (purity 99.9%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in 1-butyl-3-methylimidazolium bis(trifluoromethylsulfonyl)imide at room temperature, with the help of a fluorocarbon filament. The metallic surface area to liquid volume ratio was 0.2 mL mm⁻². The container with the ionic liquid and the suspended metal substrate was placed in a vacuum oven at 150° C. for 68 days. At the conclusion of the experiment, the substrate was removed from the solvent and quenched in demineralized water, then washed, with demineralized water, industrial methylated spirits, and acetone. This yielded to the formation of a green solid over the surface of the substrate.

### Example 16—Synthesis of a Cupro-Zinc-Oxo-Chloride Complex by Direct Oxidation of Brass in 1-butyl-3-methylimidazolium Chloride

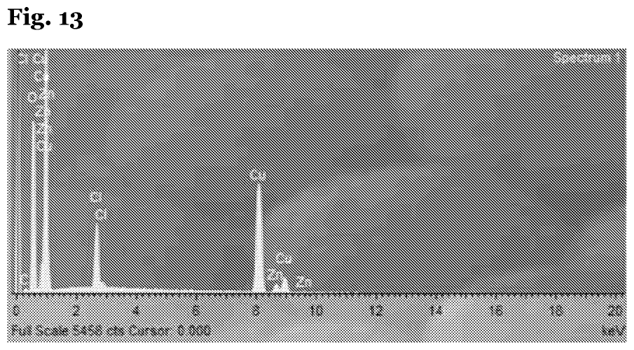

A disk of brass (Cu 63% and Zn 37%, d=18 mm and 0.125 mm thickness) with a single 0.8 mm diameter hole was used. The metal substrate was prepared at room temperature by washing with demineralized water, industrial methylated spirits, and acetone. After which, the sample was dried for 45 min at 105° C. and then cooled in a desiccator for 30 min. The metal substrate was immersed in a 1-butyl-3-methylimidazolium chloride solution with a water content of 98 mol % at room temperature, with the help of a fluorocarbon filament, for 18 days. The metallic surface area to liquid volume ratio was 0.2 mL mm⁻². At the conclusion of the experiment, the substrate was removed from the solvent and quenched in demineralized water, then washed, with demineralized water, industrial methylated spirits, and acetone. This yielded to the formation of cupro-zinc-oxo-chloride complex acicular crystals radiating from a core as depicted in FIG. 12. The EDX spectrum is shown in FIG. 13, and the complex was determined to have a Cu:Zn:O:Cl atomic ratio of 11:1:25.1:2.

### CONCLUSION

The inventors have demonstrated an Oxidative Ionothermal Synthesis (OIS) of nano/micro materials (both crystalline and amorphous) by direct oxidation of metals in an IL and water mixture. By adjusting the water content, temperature and exposure time, different species such can be obtained.

The use of a mixture comprising an IL and an oxidising agent for making nanoparticles via direct oxidation of metals (OIS) might be used to synthetize materials-by-design (as hetero-structures, core-shell structures or metals with modified surfaces) with physicochemical properties tailored to meet industrial relevant needs. Additionally, the use of these solvents in combination with metals/metalloids could lead to a more cost-effective and environmentally friendly processes for large-scale synthesize synthesis of a wide range of nano and micro materials.

While not being bound to a particular theory, it is believed that, during the course of the reactions discussed herein, the metal/metalloid precursor is first oxidised by the oxidizing agent and then partially solubilised in the polar regions of the ionic liquid, which can stabilize the metal/metalloid ions. The concentration of metal/metalloid in these environments increases until it reaches a critical concentration, which leads to nucleation of metal/metalloid compounds. These compounds undergo further growth, and by kinetic and/or thermodynamic control, are formed into microparticles or nanoparticles. The particles can grow as individual particles in the solution or attached to the precursor surface, to form a film or composite material. The ionic liquid may be selected to provide a solvent environment that is specifically designed for particular precursors and oxidising agents. Accordingly, it appears that microparticles or nanoparticles of any given composition and morphology can be produced by the synthetic pathways described herein.

1. A method of producing a metal and/or metalloid compound, the method comprising contacting a metal and/or metalloid source with a reaction mixture, wherein the reaction mixture comprises an ionic liquid and an oxidising agent, and thereby producing the metal and/or metalloid compound.

2. The method of claim 1, wherein the metal and/or metalloid source comprises or consists of a pure metal, a pure metalloid, an impure metal, an impure metalloid, an alloy, a metal containing compound or a metalloid containing compound, optionally wherein the metal and/or metalloid source comprises a metal or an alloy.

3. (canceled)

4. The method of claim 1, wherein the metal and/or metalloid source comprises or consists of aluminium, antimony, arsenic, astatine, barium, beryllium, bismuth, boron, cadmium, caesium, calcium, cerium, chromium, cobalt, copper, dysprosium, erbium, europium, gadolinium, gallium, germanium, gold, hafnium, holmium, indium, iridium, iron, lanthanum, lead, lithium, lutetium, magnesium, manganese, mercury, molybdenum, neodymium, nickel, niobium, osmium, palladium, platinum, polonium, potassium, praseodymium, rhenium, rhodium, rubidium, ruthenium, samarium, scandium, selenium, silicon, silver, sodium, tantalum, tellurium, terbium, thorium, thulium, tin, titanium, tungsten, uranium, vanadium, ytterbium, yttrium, zinc and/or zirconium.

5. The method of claim 1, wherein the metal and/or metalloid compound comprises oxygen, nitrogen, phosphorous, a halogen, sulphur, selenium, carbon and/or hydrogen, optionally wherein the metal and/or metalloid compound comprises an oxide group (O) or a hydroxide group (OH).

6. (canceled)

7. The method of claim 1, wherein the oxidising agent comprises or consists of water, hydrogen peroxide, ozone, oxygen, a halogen (e.g. fluorine, chlorine, iodine or bromine), potassium nitrate and/or a mineral acid, optionally wherein the oxidising agent is water.

8. (canceled)

9. The method of claim 1, wherein hydrogen gas is produced by the method as a co-product, and the method further comprises collecting the hydrogen gas.

10. The method of claim 1, wherein the ionic liquid consists of a cation and an anion and has a melting point or less than 350° C., optionally wherein the cation is an optionally substituted positively charged 3 to 15 membered heterocyclic ring or an optionally substituted positively charged 5 to 15 membered heteroaromatic ring.

11. (canceled)

12. The method of claim 10, wherein the cation is: 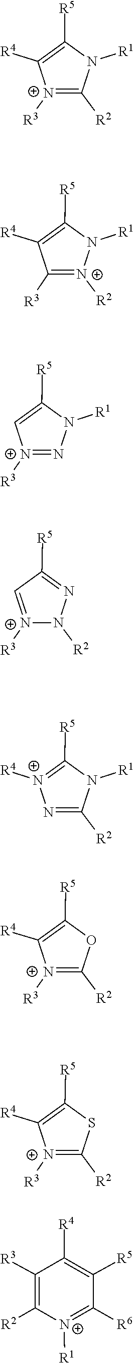 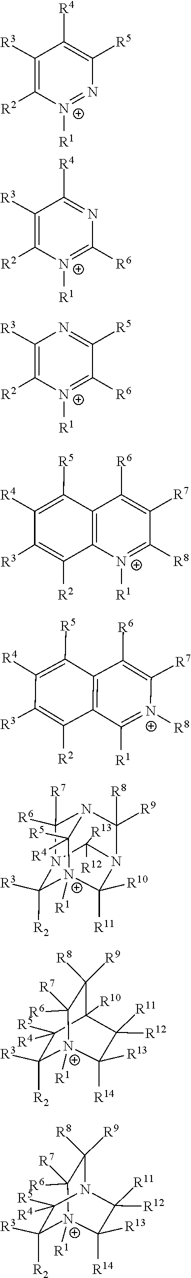 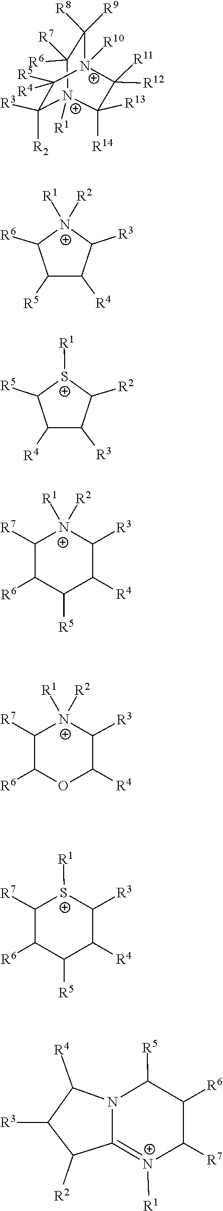 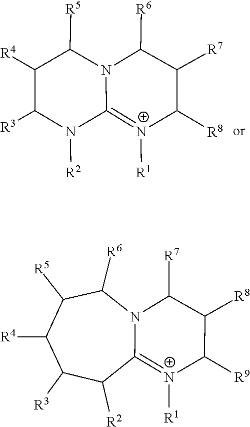
wherein R¹ to R¹⁴ are independently H, an optionally substituted C₁₋₂₄ alkyl, an optionally substituted C₂₋₂₄ alkenyl, an optionally substituted C₂₋₂₄ alkynyl, an optionally substituted C₃₋₂₄ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO₂, —Cl, —Br, —F, or —I, or two of R¹ to R¹⁴, together with the atoms to which they are attached, form an optionally substituted 3 to 15 membered ring, wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

13. The method of claim 10, wherein the cation is: 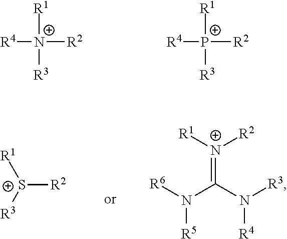
wherein R¹ to R⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO₂, —Cl, —Br, —F or —I, or two of R¹ to R⁶, together with the atoms to which they are attached, form an optionally substituted 3 to 15 membered ring wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

14. The method of claim 10, wherein the anion is F⁻, Cl⁻, Br⁻, I⁻, ClO₄⁻, 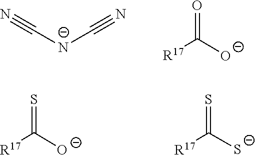
BrO₄⁻, NO₃⁻, NC⁻, NCS⁻, NCSe⁻, 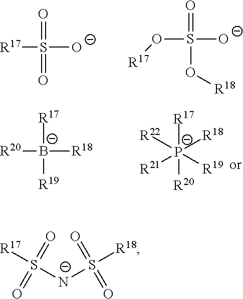
or a negatively charged metal complex, wherein R¹⁷ to R²² are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl, an optionally substituted C₆₋₁₂ aryl, —OR¹⁵, —SR¹⁵, —CN, —NR¹⁵R¹⁶, —SO₃R¹⁵, —OSO₃R¹⁵, —COR¹⁵, —COOR¹⁵, —NO₂, —Cl, —Br, —F or —I, or two of R¹⁷ to R²², together with the atoms to which they are attached, form an optionally substituted 3 to 15 membered ring, wherein R¹⁵ and R¹⁶ are independently H, an optionally substituted C₁₋₂₄ alkyl, an optionally substituted C₂₋₂₄ alkenyl, an optionally substituted C₂₋₂₄ alkynyl, an optionally substituted C₃₋₆ cycloalkyl or an optionally substituted C₆₋₁₂ aryl.

15. The method of claim 10, wherein the inorganic liquid is 1-n-butyl-3-methylimidazolium chloride, butyl-dimethylammonium hydrogen sulphate, 1-n-butyl-3-methylimidazolium bis(trifluoromethylsulfonyl)imide or methylimidazolium chloride.

16. The method according to claim 1, wherein the reaction mixture comprises or consist of the ionic liquid and the oxidizing agent in a weight ratio of between 1:1,000 and 1,000:1, between 1:750 and 750:1, between 1:500 and 500:1, between 1:250 and 250:1, between 1:100 and 100:1, between 1:50 and 50:1, between 1:25 and 25:1, between 1:15 and 15:1, between 1:10 and 10:1, between 1:7 and 7:1 or between 1:6 and 5:1.

17. The method according to claim 1, wherein the reaction mixture comprises or consists of the ionic liquid and the oxidizing agent in a molar ratio of between 1:1,000 and 100:1, between 1:500 and 50:1, between 1:250 and 10:1, between 1:100 and 5:1, between 1:80 and 3:1, between 1:70 and 21, between 1:60 and 1:1 or between 1:50 and 1:2.

18. The method according to claim 1, wherein the metal and/or metalloid source and the reaction mixture are contacted at a temperature between −50° C. and 500° C., between −25° C. and 400° C., between 0° C. and 300° C., between 5° C. and 200° C. or between 10° C. and 175° C.

19. The method according to claim 1, wherein the metal and/or metalloid source and the reaction mixture are contacted for at least 1 minute, at least 15 minutes, at least 30 minutes, at least 1 hour, at least 6 hours, at least 12 hours, at least 24 hours or at least 48 hours.

20. The method according to claim 1, wherein the method comprises separating the metal and/or metalloid compound from the ionic liquid, optionally wherein the method comprises purifying the ionic liquid after separation.

21. (canceled)

22. The method according to claim 1, wherein the method comprises heating the metal and/or metalloid compound to cause the metal and/or metalloid compound to chemically react and provide a further metal and/or metalloid compound, optionally wherein the further metal and/or metalloid compound is a metal oxide or a metalloid oxide.

23. (canceled)

24. A cupro-zinc-oxo-chloride complex.

25. The complex according to claim 24, wherein the complex comprises:
between 1 and 75 at. % copper,
between 0.1 and 20 at. % zinc,
between 5 and 90 at. % oxygen, and
between 0.1 and 30 at. % chlorine.

26. The complex according to claim 24, wherein the complex has an energy dispersive x-ray (EDX) spectrum substantially as shown in FIG. 13.
